(19) United States
(12) Patent Application Publication
(10) Pub. No.: US 2026/0167153 A1
(43) Pub. Date: Jun. 18, 2026

(54) Detecting Unauthorized Control of Unmanned Aquatic Vehicles

(71) Applicant: Saildrone, Inc., Alameda, CA (US)

(72) Inventor: Jeremy Meador, Lafayette, LA (US)

(73) Assignee: Saildrone, Inc., Alameda, CA (US)

(21) Appl. No.: 18/981,328

(22) Filed: Dec. 13, 2024

(51) Int. Cl. B60R 25/32; B60R 25/10; B63H 25/04

(52) U.S. Cl. CPC B60R 25/32; B60R 25/10; B63H 25/04

(57) ABSTRACT

Techniques are provided for detecting unauthorized control of an unmanned aquatic vehicle. One or more hardware processors determine one or more steering parameters for at least one steering component and one or more propulsion parameters for at least one propulsion component to achieve a navigation target, control the at least one steering component based on the one or more steering parameter and the at least one propulsion component based on the one or more propulsion parameters, obtain movement data of the unmanned aquatic vehicle over a time interval, determine a steering effectiveness parameter based on the one or more steering parameters and the movement data over the time interval, and based on determining that the steering effectiveness parameter is below a threshold, cause at least one communication device to transmit a notification configured to alert a recipient that the unmanned aquatic vehicle may be under control of an unauthorized entity.

### FIELD OF THE DISCLOSURE

The present disclosure generally relates to unmanned aquatic vehicles, and relates more specifically to detection of unauthorized interference with unmanned aquatic vehicles and remediation measures thereto.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely based on their inclusion in this section.

Autonomous and unmanned vehicles can perform tasks in hazardous, remote, and inaccessible environments, reducing risk to human operators and increasing safety, efficiency, and effectiveness. Unmanned aquatic vehicles are increasingly used for research, exploration, monitoring, defense, and other applications. However, because unmanned systems typically operate without human oversight, unauthorized interference can remain undetected for extended periods. Unauthorized parties, such as foreign entities, pirates, or other criminal actors, may attempt to tow, capture, disable, or otherwise seize control of an unmanned aquatic vehicle. Such actions can disrupt operations and lead to asset loss, including instruments, payloads, and the vehicle itself. Furthermore, when an unauthorized party takes control of an unmanned aquatic vehicle, sensitive information may be at risk of exposure, including mission details, operational capabilities, routes, mission data, and operational data.

### SUMMARY

The appended claims may serve as a summary.

### BRIEF DESCRIPTION OF THE DRAWINGS

In the drawings:

FIG. 1 is a block diagram illustrating an unmanned aquatic vehicle configured to detect unauthorized control in an example embodiment.

FIGS. 2A-2C illustrate example external control conditions in accordance with one or more embodiments.

FIG. 3 is a block diagram illustrating an unmanned aquatic vehicle configured to implement one or more remediation measures in an example embodiment.

FIG. 4 is a flow diagram of a process for detecting unauthorized control in an example embodiment.

FIG. 5 is a block diagram illustrating an example computer system upon which an embodiment may be implemented.

While each drawing figure illustrates a particular embodiment for the purpose of providing a clear example, other embodiments may omit, add to, reorder, or modify any of the elements shown in the drawing figures. Unless otherwise specified, aspects disclosed with respect to an embodiment of an element in a figure may optionally be applied to another embodiment of the element in another figure. For purposes of illustrating clear examples, one or more figures may be described with reference to one or more other figures. However, using the particular arrangement illustrated in such other figure/s is not required in other embodiments.

### DETAILED DESCRIPTION

In the following description, numerous specific details are set forth in order to provide a thorough understanding of the subject matter of the present application. It will be apparent, however, to a person of ordinary skill that embodiments may be practiced without incorporating all aspects of the specific details described herein. The detailed description that follows describes exemplary embodiments and the features disclosed are not intended to be limited to the expressly disclosed combination(s). Therefore, unless otherwise noted, features disclosed herein may be combined to form additional combinations that were not otherwise shown for purposes of brevity.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other, and does not imply an ordering, timing, or any other characteristic of the referenced items unless otherwise specified; the term “and/or” as used herein refers to and encompasses any and all possible combinations of one or more of the associated listed items; that the terms “includes”, “including”, “comprises”, and/or “comprising” specify the presence of stated features but do not preclude the presence or addition of one or more other features. Unless otherwise specified: “such as” is intended to mean “such as but not limited to”; and examples are intended to be nonlimiting.

As used herein, the term “component” refers to any element, module, device, part, hardware, software, firmware, or any combination thereof. As an alternative and/or addition, a component may comprise specialized circuitry and/or or mechanical assemblies designed to perform specific functions. A component may be a standalone component, work in conjunction with one or more other components, contain one or more other components, and/or belong to one or more other components. A component may perform specific functions, interact with other components, provide structure, and/or achieve certain operations.

As used herein, the terms “coupled” refers to a connection between two components, which may be direct or indirect, permitting additional intermediary components, elements, structures, or mechanisms between the coupled components. Such connections may encompass, but are not limited to, communicative connections (e.g., electronic, optical, wireless, and/or other communication pathways), mechanical connections, electromagnetic connections, and/or any other form of functional, operative, or interactive association.

As used herein, the term “system” refers to mechanical components, hardware, and/or software stored in, or coupled with, a memory and/or one or more processors on one or more computers. As an alternative and/or addition, a component may comprise specialized circuitry and/or or mechanical assemblies designed to perform specific functions. A system may be a standalone component, work in conjunction with one or more other systems, contain one or more other systems, and/or belong to one or more other systems. A system may be a computer system, mechanical system, or an integrated system that combines both mechanical and computational elements.

As used herein, the term “controller” refers to hardware, software, firmware, or combination thereof configured to control, regulate, or manage the operation of various components or functions within a system. The controller may include one or more processors, microcontrollers, programmable logic devices, or other control circuits and may execute algorithms, processes, or instructions to adjust operational parameters, monitor performance, and respond to inputs from sensors, user interfaces, or other systems. A controller may include one or multiple controllers.

As used herein, the term “computer” refers to any electronic device, system, or apparatus capable of processing data, executing instructions, or performing calculations. The computer may include one or more controllers, processors, memory, input/output interfaces, storage devices, or any combination thereof. The term encompasses desktops, laptops, servers, embedded systems, controllers, microcontrollers, and other programmable devices, whether standalone or networked, and may include software, firmware, or hardware for performing computational functions.

As used herein, the term “computer system” refers to one or more computers, such as one or more physical computers, virtual computers, and/or computing devices. For example, a computer system may be, or may include, one or more server computers, desktop computers, laptop computers, mobile devices, special-purpose computing devices with a processor, cloud-based computers, cloud-based clusters of computers, virtual machine instances, and/or other computing devices. A computer system may include another computer system, and a computing device may belong to two or more computer systems. Any reference to a “computer system” may mean one or more computers, unless expressly stated otherwise. When a computer system performs an action, the action is performed by one or more computers of the computer system.

As used herein, the term “device” refers to a mechanical system, a computer system, hardware, and/or software stored in, or coupled with, a memory and/or one or more processors on one or more computers. As an alternative and/or addition, a device may comprise specialized circuitry and/or or mechanical assemblies designed to perform specific functions. A device may be a standalone device, work in conjunction with one or more other devices, contain one or more other devices, and/or belong to one or more other devices.

### GENERAL OVERVIEW

This document generally describes systems, methods, devices, and other techniques for detecting unauthorized control of unmanned aquatic vehicles. In general, an unmanned aquatic vehicle determines control parameters for navigating, such as steering parameters and propulsion parameters. The unmanned aquatic vehicle uses at least one control parameter and movement data to evaluate the effectiveness of its steering. For example, the unmanned aquatic vehicle may generate a steering effectiveness parameter that corresponds to how successfully the unmanned aquatic vehicle is steering as intended. When the steering effectiveness parameter falls below a threshold, the unmanned aquatic vehicle may determine that it may be under control of an unauthorized entity. In response to this determination, the unmanned aquatic vehicle may perform a responsive action, such as sending a notification or carrying out one or more remediation measures.

One aspect of the disclosure is directed to an unmanned aquatic vehicle comprising: at least one communication device; at least one steering component; at least one propulsion component; and a control system comprising one or more hardware processors, and at least one memory storing one or more instructions which, when executed by the one or more hardware processors, cause the one or more hardware processors to: determine one or more steering parameters for the at least one steering component and one or more propulsion parameters for the at least one propulsion component to achieve a navigation target; control the at least one steering component based on the one or more steering parameter and the at least one propulsion component based on the one or more propulsion parameters; obtain movement data of the unmanned aquatic vehicle over a time interval; determine a steering effectiveness parameter based on the one or more steering parameters and the movement data over the time interval; and based on determining that the steering effectiveness parameter below a threshold, cause the at least one communication device to transmit a notification configured to alert a recipient that the unmanned aquatic vehicle may be under control of an unauthorized entity.

In some examples, the time interval is between about 10 seconds and about 90 seconds.

In some examples, determining that the unmanned aquatic vehicle is likely under control of an unauthorized entity is further based on determining that a speed of the unmanned aquatic vehicle is faster than a threshold speed.

In some examples, the at least one steering component comprises a rudder.

In some examples, the at least one propulsion component comprises at least one of a rigid sail and a motor.

In some examples, achieving the navigation target comprises navigating a waypoint. As an alternative and/or addition, determining the steering effectiveness parameter includes determining progress in navigating to the waypoint.

In some examples, determining the steering effectiveness parameter includes determining a turn rate based on the movement data.

In some examples, the movement data includes Global Positioning System (GPS) data.

In some examples, the instructions, when executed by the one or more hardware processors, cause the one or more hardware processors to: detect abnormal reverse movement relative to the navigation target at a speed above a threshold speed based on the movement data; and in response to detecting the abnormal reverse movement, cause the at least one communication device to transmit the notification. As an alternative and/or addition, detecting the abnormal reverse movement comprises determining that a longitudinal velocity of the unmanned aquatic vehicle toward the waypoint is negative and has a magnitude greater than the threshold speed.

In some examples, the instructions, when executed by the one or more hardware processors, cause the one or more hardware processors to: detect abnormal idle movement comprising the unmanned aquatic vehicle moving at a speed greater than a threshold speed when the at least one steering component and the at least one propulsion component are not under active control; and in response to detecting the abnormal reverse movement, cause the at least one communication device to transmit the notification.

In some examples, the unmanned aquatic vehicle includes: at least one data collection device configured to collect data; and at least one storage media configured to store the data; wherein the instructions, when executed by the one or more hardware processors, cause the one or more hardware processors to carry out a data protection measure to protect the data. As an alternative and/or addition, the data protection measure comprises keeping the data at rest in an encrypted form on the at least one storage media. As an alternative and/or addition, the data protection measure comprises deleting the data from the at least one storage media. As an alternative and/or addition, the unmanned aquatic vehicle includes: at least one storage media destruction device communicatively coupled with the control system; wherein the data protection measure comprises controlling the at least one storage media destruction device to physically destroy the at least one storage media.

In some examples, the unmanned aquatic vehicle includes: at least one scuttling device communicatively coupled with the control system; wherein the one or more instructions, when executed by the one or more hardware processors, cause the one or more hardware processors to carry out a data protection measure comprising controlling the scuttling device to sink the unmanned aquatic vehicle.

In some examples, the unmanned aquatic vehicle includes: at least one intelligence gathering device communicatively coupled with the control system; wherein the one or more instructions, when executed by the one or more hardware processors, cause the one or more hardware processors to control the at least one intelligence gathering device to collect intelligence data; and transmit the intelligence data using the at least one communication device.

In some examples, the unmanned aquatic vehicle includes: at least one disruption device communicatively coupled with the control system; wherein the one or more instructions, when executed by the one or more hardware processors, cause the one or more hardware processors to control the at least one disruption device to deploy at least one disruption mechanism.

In some examples, the unmanned aquatic vehicle includes: at least one recovery device communicatively coupled with the control system; wherein the one or more instructions, when executed by the one or more hardware processors, cause the one or more hardware processors to control the at least one recovery device to generate at least one recovery signal.

Another aspect of the disclosure is directed toa method for detecting unauthorized control of an unmanned aquatic vehicle, the method comprising: determining one or more steering parameters for at least one steering component of an unmanned aquatic vehicle and one or more propulsion parameters for at least one propulsion component of the unmanned aquatic vehicle to achieve a navigation target; controlling the at least one steering component based on the one or more steering parameter and the at least one propulsion component based on the one or more propulsion parameters; obtaining movement data of the unmanned aquatic vehicle over a time interval; determining a steering effectiveness parameter based on the one or more steering parameters and the movement data over the time interval; and when the steering effectiveness parameter is below a threshold, causing at least one communication device to transmit a notification configured to alert a recipient that the unmanned aquatic vehicle may be under control of an unauthorized entity; wherein the method is performed by one or more processors.

In some implementations, the various techniques described herein may achieve one or more of the following advantages: interference with an unmanned aquatic vessel may be rapidly detected with high accuracy and a low false positive rate; rapid detection may enable responsive actions to be taken quickly; relevant parties may be notified early, allowing for rapid response measures to be implemented; rapid implementation of remediation measures may protect sensitive information, such as intelligence and/or stored data; rapid detection may allow remediation measures to be implemented before communication and/or non-navigational control is lost; intelligence may be gathered on hostile actors; tactical measures may be carried out; a deterrence effect against unauthorized interference may be achieved. Additional features and advantages are apparent from the specification and the drawings.

### SYSTEM OVERVIEW

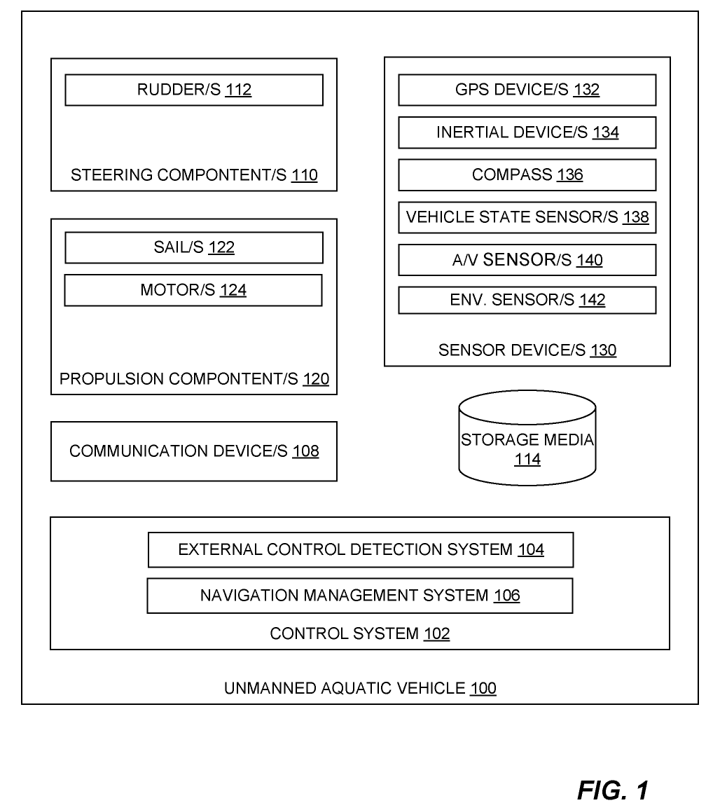

FIG. 1 is a block diagram illustrating an unmanned aquatic vehicle configured to detect unauthorized control in an example embodiment. In some embodiments, the unmanned aquatic vehicle 100 is a remotely-operated vehicle, underwater vehicle, surface vehicle, amphibious vehicle, or any other suitable unmanned aquatic vehicle. In some embodiments, the unmanned aquatic vehicle 100 is an autonomous vehicle configured to carry out at least a portion of its functionality without human intervention. For example, the unmanned aquatic vehicle 100 may be configured to receive and interpret instructions specifying a destination, task, or operational parameter. In carrying out the instructions, the unmanned aquatic vehicle 100 may make independent decisions using onboard intelligence and sensor data collected from its environment.

The unmanned aquatic vehicle 100 includes a control system 102 configured to regulate, manage, and/or direct the operation of components and/or systems of the unmanned aquatic vehicle 100. The control system 102 may include hardware, software, firmware, or any combination thereof, and may comprise one or more controllers, processors, sensors, actuators, and/or communication interfaces. The control system 102 is operable to receive inputs, execute instructions, monitor performance, and adjust operational parameters in response to changing conditions or predefined criteria. The control system 102 may be communicatively coupled with one or more power systems, communication devices 108, steering components 110, propulsion components 120, sensor devices 130, storage media 114, and/or other components. The control system 102 may be configured to autonomously perform one or more functions of the unmanned aquatic vehicle 100.

The unmanned aquatic vehicle 100 may include one or more communication devices 108 capable of receiving and/or transmitting data. For example, the communication device/s 108 may include one or more satellite devices, radio devices, wireless devices, and/or other devices capable of receiving and/or transmitting data. In some embodiments, the control system 102 operates the unmanned aquatic vehicle 100 based on one or more commands received over the communication device/s 108.

The unmanned aquatic vehicle 100 may include one or more sensor devices 130 capable of collecting data from the environment. One or more of the sensor devices 130 may be communicatively coupled with the control system 102 and/or a power system of the unmanned aquatic vehicle 100. In some embodiments, the control system 102 of the unmanned aquatic vehicle 100 uses data collected using one or more of the sensor devices 130 to monitor and/or operate the unmanned aquatic vehicle.

In some embodiments, the sensor devices 130 include one or more devices configured to obtain movement data regarding the physical location, orientation, and/or other movement of the unmanned aquatic vehicle 100, such as one or more GPS devices 132, inertial devices 134, compasses, and/or other devices capable of obtaining movement data. As an alternative and/or addition, the sensor devices 130 may include one or more audio/visual sensors 140 capable of collecting audio and/or visual data, such as microphones, sonar devices, other acoustic sensors, cameras, infrared sensors, thermal imaging sensors, lidar sensors, 3D cameras, multispectral sensors, and/or other sensors capable of collecting audio and/or visual data. As an alternative and/or addition, the sensor devices 130 may include one or more vehicle state sensors 138 configured to obtain vehicle state data describing the operation of one or more components, such as wing angle sensors, and/or other devices capable of obtaining vehicle state data. As an alternative and/or addition, the sensor device/s 130 may include one or more environmental sensors 142 configured to sample environmental parameters, such as one or more thermometers, salinity sensors, dissolved oxygen sensors, turbidity sensors, pH sensors, wind sensors, light sensors, current sensors, barometers, or any other sensor capable of sampling an environmental parameter. As an alternative and/or addition, the unmanned aquatic vehicle 100 may include one or more other data collection sensors capable of collecting data from the environment.

One or more data elements collected by the sensor devices 130 may be transmitted using the communication devices 108. In some embodiments, the control system 102 may filter, summarize, aggregate, or otherwise process sensor data to generate reporting data for transmission using the communication device/s 108.

As an alternative and/or addition, one or more data elements collected by the sensor devices 130 may be stored in storage media 114 disposed on the unmanned aquatic vehicle 100. For example, the control system 102 may write sensor data to the storage media 114, including raw data and/or processed data. In some embodiments, the control system 102 may write operational data describing the operation of the unmanned aquatic vehicle 100 to the storage media 114. As used herein, the term “storage media” refers to any storage device comprising a physical medium capable of storing data in digital or analog form, such as magnetic media (e.g., hard drives, floppy disks, magnetic tapes), optical media (e.g., CDs, DVDs, Blu-ray discs), solid-state media (e.g., flash drives, memory cards, SSDs), hybrid storage systems combining multiple technologies, or any other medium capable of storing data. The storage media 114 may include one or multiple storage devices.

In some embodiments, the unmanned aquatic vehicle 100 may be deployed on a mission to collect data using one or more sensor devices 130. For example, the unmanned aquatic vehicle 100 may be deployed on a bathymetric mission to survey the ocean floor and collect bathymetric data using acoustic sensors. In some embodiments, one or more of the sensor devices 130 are deployed on a payload unit removably disposed on the unmanned aquatic vehicle 100. For example, the payload unit may be removably disposed in a payload bay configured to receive the payload unit. In some embodiments, the payload unit may include an independent controller, an independent power source, an independent sensor, an independent communication device, and/or an independent logging device. Techniques described herein with respect to the storage media 114 of the unmanned aquatic vehicle 100 may be applied to a payload unit’s independent storage media without departing from the spirit or the scope of this disclosure.

In some embodiments, the control system 102 includes a navigation management system 106 configured to control navigation of the unmanned aquatic vehicle 100. For example, the navigation management system 106 may be implemented by a controller of the control system 102 that is configured to carry out navigation management functionality. In some embodiments, the navigation management system 106 navigates the unmanned aquatic vehicle 100 to a navigation target. A navigation target may include any parameter describing a destination location or direction of travel, such as but not limited to one or more coordinates, points, regions, geometries, boundaries, radiuses, headings relative to wind, absolute headings, bearings, vectors, angles, paths, corridors, and/or any other destination location or direction of travel. One or more navigation targets may be stored in memory and/or received over the communication device/s 108. As an alternative and/or addition, the navigation management system 106 may autonomously determine one or more navigation targets. The navigation management system 106 may navigate to one or more navigation targets by autonomously determining control parameters for controlling the unmanned aquatic vehicle 100. The navigation management system 106 may use movement data and/or other sensor data to determine the control parameters.

The unmanned aquatic vehicle 100 may include one or more steering components 110. For example, the steering component/s 110 may include one or more rudders 112, thrusters, and/or any other system capable of steering the unmanned aquatic vehicle 100. In some embodiments, the navigation management system 106 determines one or more steering parameters for the steering component/s 110 and controls the steering component/s 110 based on the one or more steering parameters. For example, when navigating the unmanned aquatic vehicle 100, the navigation management system 106 may calculate a rudder angle for a rudder 112 and transmit signals to one or more actuators configured to adjust the angle of the rudder 112 based on the rudder angle. The control system 102 may include actuator/s and/or any intermediate control elements, such as trim tab, and may control the steering component/s using such intermediate control elements.

The unmanned aquatic vehicle 100 may include one or more propulsion components 120. For example, the propulsion component/s 120 may include one or more sails 122, motors 124, foils, and/or any other system capable of providing propulsion for the unmanned aquatic vehicle 100. In some embodiments, the propulsion component/s 120 includes a sail 122 comprising a rigid wing sail. As an alternative and/or addition, the propulsion component/s 120 may include a motor 124 comprising a direct-drive electric motor, a geared electric motor, brushless DC (BLDC) motor, an asynchronous motor, a gas motor, a hybrid motor, or any other motor capable of powering a propulsion system, such as a propeller system and/or jet propulsion system. In some embodiments, the navigation management system 106 determines one or more propulsion parameters for the propulsion component/s 120 and controls the propulsion component/s 120 based on the one or more propulsion parameters. For example, when navigating the unmanned aquatic vehicle 100, the navigation management system 106 may calculate a wing angle for a sail 122 to generate a desired amount of lift, and transmit signals to one or more actuators configured to adjust the angle of the sail 122 based on the wing angle. As an alternative and/or addition, the navigation management system 106 may calculate motor inputs such as gears, speed, directional control (e.g., forward or reverse), fuel flow, air flow, timing, gear selection, and/or other parameters to control a propulsion system driven by one or more motors 124. The control system 102 may include actuator/s and/or any intermediate control elements, such as trim tabs, and may control the propulsion component/s using such intermediate control elements.

In some embodiments, one or more components of an unmanned aquatic vehicle 100 may provide both propulsion and steering, such as but not limited to a tiltable foil, propellers of a thruster system, a jet, or any other component operable for both propulsion and steering. When the control system 102 determines a control parameter for such dual-purpose components, one or more embodiments described herein may be adapted to take into account the intended usage of the dual-purpose components without departing from the spirit or the scope of this disclosure.

### EXTERNAL CONTROL DETECTION SYSTEM

In some embodiments, the control system 102 includes an external control detection system 104 configured to detect when the unmanned aquatic vehicle 100 is likely under control of an unauthorized entity, also referred to herein as “detecting unauthorized control.” In some embodiments, the external control detection system 104 may be implemented by a controller of the control system 102 that is configured to carry out external control detection functionality. Examples of unauthorized entities include foreign state actors, quasi-state actors, paramilitary groups, terrorist organizations, operators of an unaffiliated vehicle, parties engaging in illegal activity, or any other party that is not authorized to interact with the unmanned aquatic vehicle 100. The unauthorized entities may perform unauthorized acts, such as towing the unmanned aquatic vehicle 100, retrieving the unmanned aquatic vehicle 100 from the water, and/or otherwise seizing or interfering with the unmanned aquatic vehicle 100. In some embodiments, the unauthorized acts may include moving the unmanned aquatic vehicle 100 into or out of a zone where a foreign state actor has jurisdictional rights and/or the right to exclude operation of the unmanned aquatic vehicle 100 by legitimate operators, such as international waters, territorial waters, contiguous zones, exclusive economic zones, military exclusion zones, environmental protection zones, maritime safety zones, fisheries, disputed waters, or other jurisdictional zones.

In some embodiments, the external control detection system 104 detects unauthorized control based on one or more steering parameters used to control the steering component/s 110. The external control detection system 104 may use available steering parameters as indicators of intended steering direction, intended steering rate, and/or any other indicator regarding intended steering control by the navigation management system 106. For example, a rudder angle for a rudder may indicate an intended turning direction and an intended rate of the turn.

As an alternative and/or addition, the external control detection system 104 may detect unauthorized control based on one or more propulsion parameters used to control the propulsion component/s 120. The external control detection system 104 may use available propulsion parameters as indicators of intended propulsion direction, intended propulsion magnitude, and/or any other indicator regarding intended propulsion control by the navigation management system 106. In some embodiments, the external control detection system 104 determines whether the unmanned aquatic vehicle 100 is in an idle state based on available propulsion parameters. As an alternative and/or addition, the external control detection system 104 may determine the intended thrust direction of the navigation management system 106 based on available propulsion parameters. For example, a wing angle for a rigid wing sail may indicate an intended amount of lift as well as an intended thrust direction. As another example, propulsion parameters for controlling a motor may indicate an intended thrust direction and/or an idle state.

In some embodiments, the external control detection system 104 detects unauthorized control based on a combination of steering parameter/s and propulsion parameter/s. In some embodiments, the navigation management system 106 may directly provide one or more steering parameters and/or one or more propulsion parameters to the external control detection system 104. For example, when the navigation management system 106 and the external control detection system 104 are implemented on the same controller, the external control detection system 104 may directly access parameter values and/or other state information.

In some embodiments, the external control detection system 104 detects unauthorized control based on movement data of the unmanned aquatic vehicle 100, including movement data collected by the sensor device/s 130. For example, the external control detection system 104 may detect unauthorized control based on GPS data, inertial data, compass data, vehicle state data, environmental sensor data, and/or other sensor data. The external control detection system 104 may use movement data to determine actual movement parameters of the unmanned aquatic vehicle 100, such as speed over ground, course over ground, absolute heading, velocity, lateral velocity, longitudinal velocity, angular velocity, and/or other parameters describing the actual movement of the unmanned aquatic vehicle over time. As described in greater detail hereinafter, such parameters may be used to detect external control conditions that indicate that the unmanned aquatic vehicle 100 is likely under control of an unauthorized entity.

In some embodiments, the external control detection system 104 detects unauthorized control based on one or more estimated parameters. An estimated parameter may approximate a value that requires unavailable sensors to measure and/or values that require computationally complex modeling to calculate. In some instances, an estimated parameter for a value may be sufficient to accurately detect unauthorized control. An estimated parameter may be constant or may vary dynamically. For example, an estimated parameter may be based on the value of a variable. As an alternative and/or addition, different values for an estimated parameter may be selected based on operating conditions, weather forecasts, the configuration and/or model of the unmanned aquatic vehicle 100, and/or other factors. In some embodiments, the external control detection system 104 uses an environmental tolerance to account for one or more environmental conditions. For example, the environmental tolerance may correspond to a threshold speed. In some embodiments, the environmental tolerance is based on expected currents.

In some embodiments, detecting unauthorized control is based on steering parameter/s, propulsion parameter/s, and/or movement data over a time interval. The time interval may be constant or may vary. For example, the time interval may be based on the value of a variable. As an alternative and/or addition, different durations for the time interval may change depending on operating conditions, weather forecasts, the configuration and/or model of the unmanned aquatic vehicle 100, the risk of unauthorized control in an area or situation, and/or other factors. The time interval may be any suitable interval of time, such as between about 10 seconds to about 90 seconds. The time interval may function to reduce noise, such as instantaneous moves (e.g., due to environmental factors, transient dynamics in response to control adjustments), response lag (e.g. between control adjustments and vehicle response), and/or other factors.

In some embodiments, the external control detection system 104 detects external control conditions over a time interval during which steering parameter/s and or propulsion parameter/s are consistent. For example, after one or more steering parameters and/or propulsion parameters are set by the navigation management system 106, the external control detection system 104 may begin evaluating movement data over a time interval to detect one or more external control conditions. When the interval is over, the external control detection system 104 may continue to evaluate the movement data, such as by continuously evaluating the movement data over a sliding time interval (e.g., the last x seconds). As an alternative and/or addition, the external control detection system 104 may restart evaluation over a new time interval.

The external control detection system 104 may perform one or more responsive actions after detecting unauthorized control, such as sending one or more notifications configured to alert a recipient that the unmanned aquatic vehicle 100 may be under control of an unauthorized entity, carrying out one or more data protection measures, carrying out one or more tactical measure, carrying out one or more other remediation measures, and/or performing any other suitable responsive action/s. Example responsive actions are described in greater detail hereinafter.

### EXTERNAL CONTROL CONDITIONS

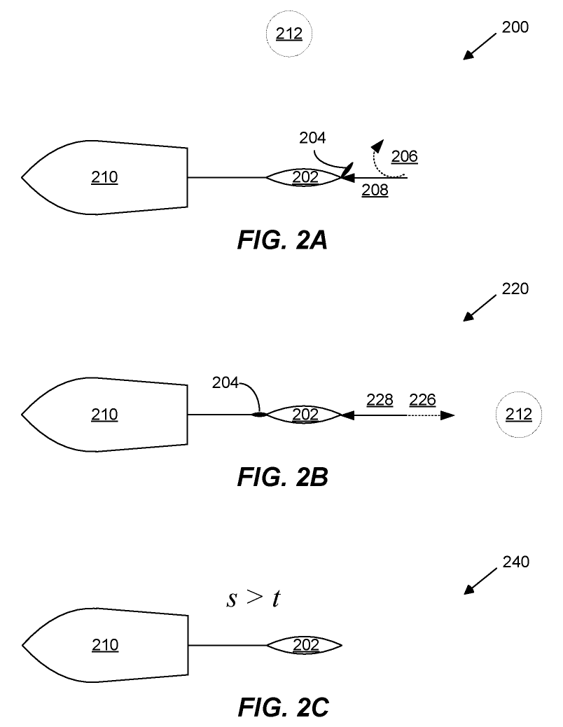

In some embodiments, the external control detection system 104 detects unauthorized control by detecting the occurrence of one or more external control conditions. As used herein, an “external control condition” refers to a set of one or more conditions that, when detected, may indicate that the unmanned aquatic vehicle 100 is likely under control of an unauthorized entity. FIGS. 2A-2C illustrate example external control conditions in accordance with one or more embodiments. Detection of unauthorized control is not limited to detection of the example external control conditions.

### EXAMPLE EXTERNAL CONTROL CONDITION: INEFFECTIVE STEERING

In some embodiments, an unmanned aquatic vehicle 202 detects that it is likely under control of an unauthorized entity based on detecting an ineffective steering condition. An example of an ineffective steering condition is illustrated in FIG. 2A. The unmanned aquatic vehicle 202 is under control of an unauthorized vessel 210. The unmanned aquatic vehicle 202 sets the rudder 204 to starboard to steer to a navigation target 212. During a subsequent time interval, the corresponding movement data indicates that observed movement 208 of the unmanned aquatic vehicle 202 deviates from the intended movement 206 of the unmanned aquatic vehicle 202. In some embodiments, detecting an ineffective steering condition is based on comparing an observed turn rate of the unmanned aquatic vehicle 202 against an intended turn rate and/or intended turn direction.

In some embodiments, the unmanned aquatic vehicle 202 detects unauthorized control based on a steering effectiveness parameter. The steering effectiveness parameter indicates the effectiveness of the unmanned aquatic vehicle 202 in controlling its steering, such as its movement, direction, orientation, and/or any other measure of steering control. In some embodiments, the steering effectiveness parameter is determined based on one or more steering parameters (e.g., rudder angle) used to control one or more steering components (e.g., rudder 204) and movement data of the unmanned aquatic vehicle 202 over a time interval. For example, the steering effectiveness parameter may be based on steering parameters and observed movement parameters, such as path, speed, velocity, angular velocity, or other movement parameters. In some embodiments, the ineffective steering condition is determined when the steering effectiveness parameter is below a threshold.

In some embodiments, detecting an ineffective steering condition is based on determining that the unmanned aquatic vehicle 202 is moving faster than an environmental tolerance. For example, when the unmanned aquatic vehicle 202 uses wind propulsion in low wind conditions the unmanned aquatic vehicle 202, currents may cause poor steering control. The unmanned aquatic vehicle 202 may be configured to detect the ineffective steering condition associated with unauthorized control only when the unmanned aquatic vehicle 202 is moving sufficiently fast to steer effectively in expected current.

### EXAMPLE EXTERNAL CONTROL CONDITION: ABNORMAL REVERSE MOVEMENT

In some embodiments, an unmanned aquatic vehicle 202 detects that it is likely under control of an unauthorized entity based on detecting an abnormal reverse movement condition. An example of an abnormal reverse movement condition is illustrated in FIG. 2B. In FIG. 2B, the unmanned aquatic vehicle 202 is under control of an unauthorized vessel 210 towing the unmanned aquatic vehicle 202 in the opposite direction of the navigation target 212. During a subsequent time interval, the corresponding movement data indicates that the observed movement 228 of the unmanned aquatic vehicle 202 is opposite of the intended movement 226 toward the navigation target 212.

The unmanned aquatic vehicle 202 detects the abnormal reverse movement condition based on movement data indicating that the unmanned aquatic vehicle 202 is moving away from the navigation target at a speed that is greater than an environmental tolerance. In some embodiments, the unmanned aquatic vehicle 202 determines a longitudinal velocity, or a velocity component along an axis aligned with the heading of the unmanned aquatic vehicle 202. The unmanned aquatic vehicle 202 may be configured to detect the abnormal reverse movement condition when the longitudinal velocity is negative and has a magnitude greater than the environmental tolerance. For example, the environmental tolerance may reflect a speed that is sufficiently faster than estimated surface currents, indicating that the negative longitudinal velocity is likely due to unauthorized control.

In some embodiments, the abnormal reverse movement condition is intended to trigger detection in an edge case of the ineffective steering condition. The unmanned aquatic vehicle 202 happens to be oriented correctly for steering towards the navigation target 214, so the ineffective steering condition of FIG. 2A will not be detected.

### EXAMPLE EXTERNAL CONTROL CONDITION: EXCESS IDLE MOVEMENT

In some embodiments, an unmanned aquatic vehicle 202 detects that it is likely under control of an unauthorized entity based on detecting an excess idle movement condition. An example of an excess idle movement condition is illustrated in FIG. 2C. In FIG. 2C, the unmanned aquatic vehicle 202 is under control of an unauthorized vessel 210 that is towing the unmanned aquatic vehicle 202 while it is in an idle state. The unmanned aquatic vehicle 202 may be idle when no propulsion components are active. During a time interval, the movement data indicates that the observed speed s of the unmanned aquatic vehicle 202in any direction is greater than the environmental tolerance t.

In some embodiments, the unmanned aquatic vehicle 202 evaluates movement data to detect one or multiple external control conditions. For example, the unmanned aquatic vehicle 202 may be configured to detect the ineffective steering condition, the abnormal reverse movement condition, and the excess idle movement condition. The unmanned aquatic vehicle 202 may determine that it is likely under control of an unauthorized entity based on the detection of any of these conditions.

The unmanned aquatic vehicle 202 may detect unauthorized control in near real-time. For example, when an unauthorized entity begins interfering with steering control, the unmanned aquatic vehicle 202 may detect unauthorized control as soon as an external control condition is detected over a subsequent time interval. Rapid detection can be critical to address unauthorized control. By implementing detection based on steering effectiveness, detecting unauthorized control does not require an unauthorized entity to remove the unmanned aquatic vehicle 202 from a bounded area or operating area before detection.

### RESPONSIVE ACTIONS

In response to detecting unauthorized control, the unmanned aquatic vehicle 202 may perform one or more responsive actions. In some embodiments, the unmanned aquatic vehicle 202 transmits a notification configured to alert a recipient that the unmanned aquatic vehicle 202 may be under control of an unauthorized entity. The unmanned aquatic vehicle may transmit the notification using at least one communication device (e.g., communication devices 108). The unmanned aquatic vehicle 202 may transmit the notification over multiple communication channels. In some embodiments, the unmanned aquatic vehicle 202 transmits the notification to multiple parties, such as an owner and/or operator of the unmanned aquatic vehicle 202, a customer involved in the deployment of the unmanned aquatic vehicle 202, a government agency, a law enforcement agency, a military force, a security company, and/or any other relevant party that may respond to or have interest in the occurrence of an unauthorized act.

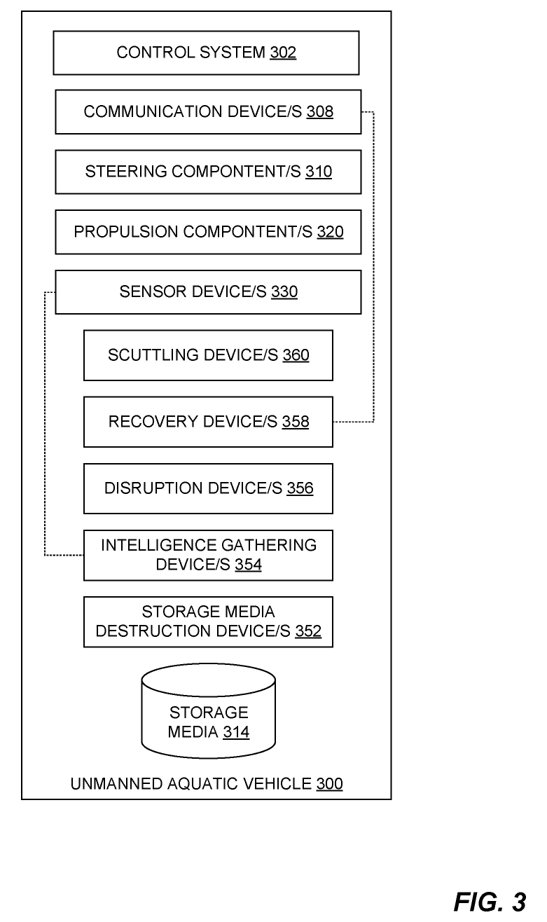

In some embodiments, the unmanned aquatic vehicle 202 is configured to carry out one or more remediation measures. FIG. 3 is a block diagram illustrating an unmanned aquatic vehicle configured to implement one or more remediation measures in an example embodiment. The unmanned aquatic vehicle 300 includes a control system 302, one or more communication devices 308, one or more steering components 310, one or more propulsion components 320, one or more sensor devices 330, and storage media 314.

In some embodiments, the unmanned aquatic vehicle 300 is configured to carry out one or more remediation measures after detecting that the unmanned aquatic vehicle 300 is likely under control of an unauthorized entity. The remediation measures may include data protection measures, tactical measures, recovery measures, and/or any other suitable measure for addressing potential unauthorized control of the unmanned aquatic vehicle 300. In some embodiments, a remediation measure may be carried out after receiving instructions to carry out the remediation measure. As an alternative and/or addition, one or more remediation measures may be automatically carried out in response to detecting unauthorized control.

In some embodiments, after the control system 302 detects unauthorized control and transmits a notification indicating that unauthorized control has been detected, the control system 302 is configured to carry out one or more remediation measures in response to one or more instructions received over the communication device/s 308. For example, a recipient of the notification may instruct the unmanned aquatic vehicle 300 to carry out at least one available remediation measure.

In some embodiments, the control system 302 may be configured to only carry out instructions to perform a remediation measure in response to a notification that unauthorized control has been detected. As an alternative and/or addition, the control system 302 may be configured to only carry out instructions to perform a remediation measure if the detection of unauthorized control is ongoing when the instructions are received. As an alternative and/or addition, the control system 302 may enable authorized parties to initiate one or more remediation measures independently of whether unauthorized control has been detected.

In some embodiments, the control system 302 is configured to carry out a data protection measure to protect data stored on the storage media 314. For example, the control system 302 may be configured to delete at least a portion of data stored on the storage media 314. As an alternative and/or addition, the control system 302 may be configured to encrypt at least a portion of data stored on the storage media 314. As an alternative and/or addition, the control system 302 may be configured to encrypt at least a portion of the data using an enhanced level of encryption. The data may be encrypted and/or deleted in accordance with one or more security standards or guidelines, such as encryption protocols, overwriting protocols, cryptographic erasure, and/or other techniques.

In some embodiments, the control system 302 is configured to keep data at rest in an encrypted form on the storage media 314 by default. When unauthorized control is detected, the control system 302 may stop accessing sensitive data such that the sensitive data stays at rest in the encrypted form. For example, the control system may stop accessing data other than essential operational data necessary to continue basic operation of the unmanned aquatic vehicle 300.

In some embodiments, the unmanned aquatic vehicle 300 includes one or more storage media destruction devices 352 configured to destroy and/or disable the storage media 314, such as shredding devices, crushing devices, drilling devices, explosive devices, incendiary devices, thermal devices, magnetic and/or degaussing devices, corrosive chemical dispensers, and/or any other suitable device capable of physically destroying and/or disabling the storage media. The storage media destruction device/s 352 may be communicatively coupled with the control system 302. The control system 302 may be configured to control the storage media destruction device/s 352 as a data protection measure to prevent unauthorized access to data stored on the storage media 314 by an unauthorized entity in physical possession of the unmanned aquatic vehicle 300.

In some embodiments, the unmanned aquatic vehicle 300 includes one or more scuttling devices 360 configured to sink the unmanned aquatic vehicle 300, such as explosive devices, controlled flooding devices, and/or any other suitable device capable of sinking the unmanned aquatic vehicle 300. The scuttling device/s 360 may be communicatively coupled with the control system 302. The control system 302 may be configured to control the scuttling device/s 360 to sink the unmanned aquatic vehicle 300. For example, the control system 302 may be configured to activate one or more scuttling devices 360 as a data protection measure, such as to prevent unauthorized access to the data stored on the storage media 314 and/or to protect other intelligence data on the unmanned aquatic vehicle 300.

In some embodiments, the unmanned aquatic vehicle 300 includes one or more intelligence gathering devices 354 configured to collect intelligence data, such as auditory data, video data, geospatial data, and/or any other intelligence data. For example, the intelligence data may provide situational awareness and/or inform decision-making processes regarding an event involving unauthorized entities interfering with the unmanned aquatic vehicle 300. The control system 302 may transmit the intelligence data using the communication devices 308. The intelligence gathering device/s 354 may be communicatively coupled with the control system 302. The control system 302 may be configured to control the intelligence gathering device/s 354 to collect intelligence data. For example, the control system 302 may be configured to activate one or more intelligence gathering devices 354 as a tactical measure. In some embodiments, the control system 302 is configured to turn on and use one or more high-bandwidth communication devices to transmit intelligence data.

In some embodiments, the unmanned aquatic vehicle 300 includes one or more disruption devices 356 capable of deploying one or more disruption mechanisms, such as loud sirens, strobes, chemical dispersal mechanisms, and/or any other suitable disruption mechanism. The disruption device/s 356 may be communicatively coupled with the control system 302. The control system 302 may be configured to control the disruption device/s 356 to deploy at least one disruption mechanism. For example, the control system 302 may be configured to activate one or more disruption devices 356 as a tactical measure.

In some embodiments, the unmanned aquatic vehicle 300 includes one or more recovery devices 358configured to generate at least one recovery signal, such as a beacon, audible alarm, distress signals, and/or any other suitable recovery signal usable to locate and/or recover the unmanned aquatic vehicle 300. In some embodiments, one or more recovery devices 358 may be configured to operate independently of the one or more communication devices 308. As an alternative and/or addition, one or more recovery signals may be transmitted via the one or more communication devices 308. The recovery device/s 358 may be communicatively coupled with the control system 302. The control system 302 may be configured to control the recovery device/s 358 to generate at least one recovery signal. For example, the control system 302 may be configured to activate one or more recovery devices 358 as a recovery measure.

### EXAMPLE PROCESSES

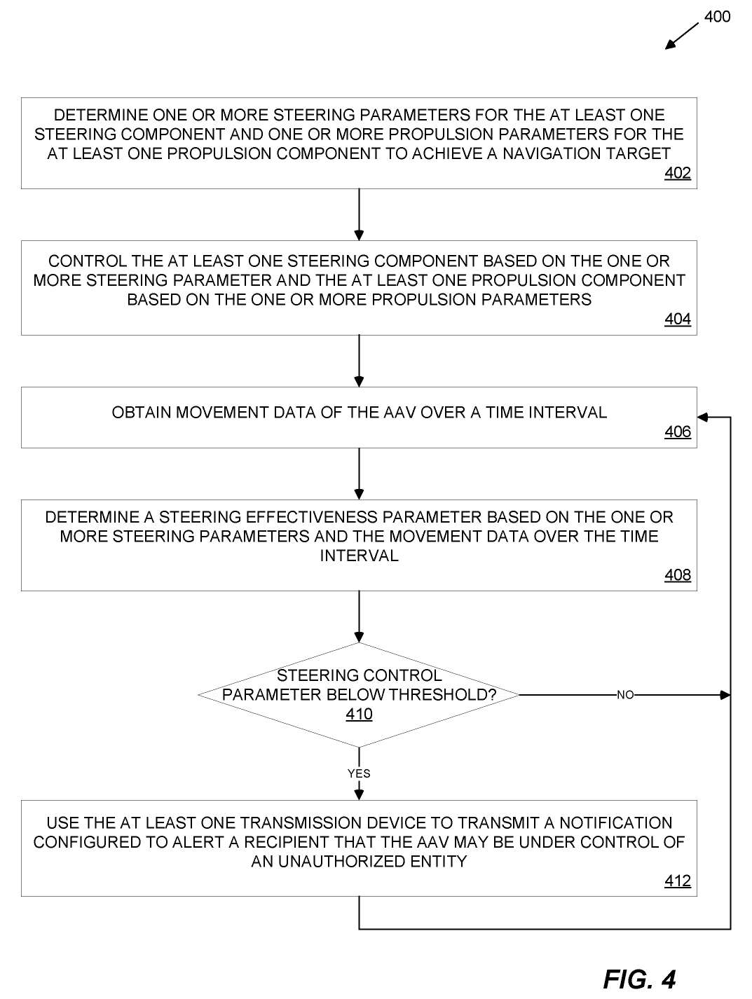

FIG. 4 is a flow diagram of a process for detecting unauthorized control of an unmanned aquatic vehicle in an example embodiment. Process 400 may be performed by one or more computing devices and/or processes thereof. For example, one or more blocks of process 400 may be performed by a computer system, such as but not limited to computer system 500. In some embodiments, one or more blocks of process 400 are performed by a control system of an unmanned aquatic vehicle, such as control system 102. Process 400 will be described with respect to the external control detection system 104 of FIG. 1, but is not limited to performance by such.

At block 402, the external control detection system 104 determines one or more steering parameters for the at least one steering component and one or more propulsion parameters for the at least one propulsion component to achieve a navigation target.

At block 404, the external control detection system 104 controls the at least one steering component based on the one or more steering parameter and the at least one propulsion component based on the one or more propulsion parameters.

At block 406, the external control detection system 104 obtains movement data of the unmanned aquatic vehicle over a time interval.

At block 408, the external control detection system 104 controls determines a steering effectiveness parameter based on the one or more steering parameters and the movement data over the time interval.

At decision block 410, the external control detection system 104 determines whether the steering effectiveness parameter is below a threshold. When the steering effectiveness parameter is below the threshold, processing continues to block 412.

At block 412, based on determining that the steering effectiveness parameter is below the threshold, the external control detection system 104 causes the at least one communication device to transmit a notification configured to alert a recipient that the unmanned aquatic vehicle may be under control of an unauthorized entity.

Process 400 returns and/or terminates after block 412 or a negative determination at decision block 410. For example, process 400 may pass control to a calling process, generate any appropriate record or notification, return after a method or function invocation, process the next operation requested by a client device, or terminate. In some embodiments, processing returns to block 406 to continue detecting for unauthorized control over subsequent time intervals based on subsequent movement data, subsequent steering parameters, and/or subsequent propulsion parameters.

### IMPLEMENTATION MECHANISMS—HARDWARE OVERVIEW

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field-programmable gate arrays (FPGAs) that are persistently programmed to perform the techniques. Alternatively and/or in addition, the one or more special-purpose computing devices may include one or more general-purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, and/or any other device that incorporates hard-wired or program logic to implement the techniques.

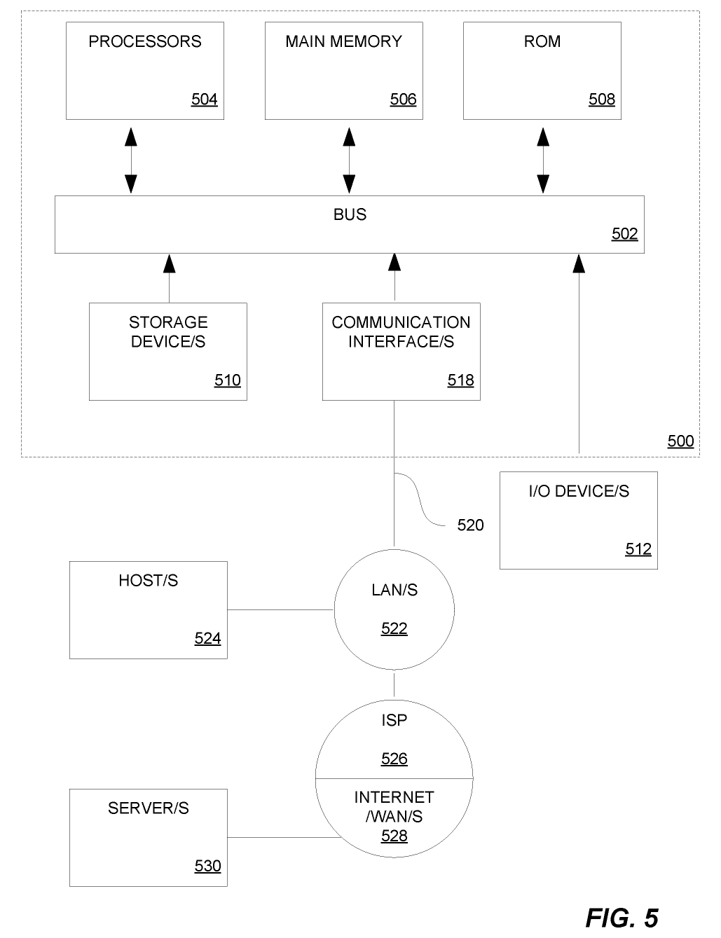

FIG. 5 is a block diagram that illustrates a computer system 500 upon which one or more embodiments described herein may be implemented. The computer system 500 includes a bus 502 or another communication mechanism for communicating information, and one or more hardware processors 504 coupled with bus 502 for processing information, such as computer instructions and data. The hardware processor/s 504 may include one or more general-purpose microprocessors, graphical processing units (GPUs), coprocessors, central processing units (CPUs), and/or other hardware processing units. As an alternative or addition, one or more computer systems 500 may be configured to provide a cloud computing environment, virtual machine, and/or other software-based emulation of a physical computing environment upon which one or more embodiments described herein may be implemented.

The computer system 500 also includes one or more units of main memory 506 coupled to the bus 502, such as random-access memory (RAM) or other dynamic storage, for storing information and instructions to be executed by the processor/s 504. Main memory 506 may also be used for storing temporary variables or other intermediate information during execution of instructions to be executed by the processor/s 504. Such instructions, when stored in non-transitory storage media accessible to the processor/s 504, turn the computer system 500 into a special-purpose machine that is customized to perform the operations specified in the instructions. In some embodiments, main memory 506 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

The computer system 500 may further include one or more units of read-only memory (ROM) 508 or other static storage coupled to the bus 502 for storing information and instructions for the processor/s 504 that are either always static or static in normal operation but reprogrammable. For example, the ROM 508 may store firmware for the computer system 500. The ROM 508 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 510, such as a magnetic disk or optical disk, is provided and coupled to the bus 502 for storing information and/or instructions. The storage device/s 510 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid-state drives, flash memory, optical disks, one or more forms of non-volatile random-access memory (NVRAM), and/or other non-volatile storage media.

The computer system 500 may be coupled via the bus 502 to one or more input/output (I/O) devices 512. For example, the I/O device/s 512 may include one or more displays for displaying information to a computer user, such as a cathode ray tube (CRT) display, a Liquid Crystal Display (LCD) display, a Light-Emitting Diode (LED) display, a projector, and/or any other type of display.

The I/O device/s 512 may also include one or more input devices, such as an alphanumeric keyboard and/or any other keypad device. The one or more input devices may also include one or more cursor control devices, such as a mouse, a trackball, a touch input device, or cursor direction keys for communicating direction information and command selections to the processor 504 and for controlling cursor movement on another I/O device (e.g. a display). A cursor control device typically has at degrees of freedom in two or more axes, (e.g. a first axis x, a second axis y, and optionally one or more additional axes z), that allows the device to specify positions in a plane. In some embodiments, the one or more I/O device/s 512 may include a device with combined I/O functionality, such as a touch-enabled display.

Other I/O device/s 512 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with the processor/s 504 over the bus 502.

The computer system 500 may implement the techniques described herein using customized hard-wired logic, one or more ASICs or FPGAs, firmware, and/or program logic that causes computer system 500 to be a special-purpose machine. According to one embodiment, the techniques herein are performed by the computer system 500 in response to the processor/s 504 executing one or more sequences of one or more instructions contained in main memory 506. Such instructions may be read into main memory 506 from another storage medium, such as the one or more storage device/s 510. Execution of the sequences of instructions contained in main memory 506 causes the processor/s 504 to perform the process steps described herein. In alternative embodiments, hard-wired circuitry may be used in place of or in combination with software instructions.

The computer system 500 also includes one or more communication interfaces 518 coupled to the bus 502. The communication interface/s 518 provide two-way data communication over one or more physical or wireless network links 520 that are connected to a local network 522 and/or a wide area network (WAN), such as the Internet. For example, the communication interface/s 518 may include an integrated services digital network (ISDN) card, cable modem, satellite modem, or a modem to provide a data communication connection to a corresponding type of telephone line. Alternatively and/or in addition, the communication interface/s 518 may include one or more of: a local area network (LAN) device that provides a data communication connection to a compatible local network 522; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network; and other networking devices that establish a communication channel between the computer system 500 and one or more LANs 522 and/or WANs.

The network link/s 520 typically provides data communication through one or more networks to other data devices. For example, the network link/s 520 may provide a connection through one or more local area networks 522 (LANs) to one or more host computers 524 or to data equipment operated by an Internet Service Provider (ISP) 526. The ISP 526 provides connectivity to one or more wide area networks 528, such as the Internet. The LAN/s 522 and WAN/s 528 use electrical, electromagnetic, or optical signals that carry digital data streams. The signals through the various networks and the signals on the network link/s 520 and through the communication interface/s 518 are example forms of transmission media or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire, and fiber optics, including traces and/or other physical electrically conductive components that comprise the bus 502. Transmission media can also take the form of acoustic or light waves, such as those generated during radio-wave and infrared data communications.

Various forms of media may be involved in carrying one or more sequences of one or more instructions to the processor 504 for execution. For example, the instructions may initially be carried on a magnetic disk or solid-state drive of a remote computer. The remote computer can load the instructions into its main memory 506 and send the instructions over a telecommunications line using a modem. A modem local to the computer system 500 can receive the data on the telephone line and use an infrared transmitter to convert the data to an infrared signal. An infra-red detector can receive the data carried in the infra-red signal and appropriate circuitry can place the data on the bus 502. The bus 502 carries the data to main memory 506, from which the processor 504 retrieves and executes the instructions. The instructions received by main memory 506 may optionally be stored on the storage device 510 either before or after execution by the processor 504.

The computer system 500 can send messages and receive data, including program code, through the network(s), the network link 520, and the communication interface/s 518. In the Internet example, one or more servers 530 may transmit signals corresponding to data or instructions requested for an application program executed by the computer system 500 through the Internet 528, ISP 526, local network 522 and a communication interface 518. The received signals may include instructions and/or information for execution and/or processing by the processor/s 504. The processor/s 504 may execute and/or process the instructions and/or information upon receiving the signals by accessing main memory 506, or at a later time by storing them and then accessing them from the storage device/s 510.

### OTHER ASPECTS OF DISCLOSURE

Although the concepts herein have been described with reference to particular embodiments, it is to be understood that these embodiments are merely illustrative of the principles and applications of the present disclosure. Unless otherwise specified, descriptions of individual elements depicted in one drawing are understood to optionally apply to similar elements depicted in other drawings, either individually or in combination. It is therefore to be understood that numerous modifications may be made to the illustrative embodiments and that other arrangements may be devised without departing from the spirit and scope of the present disclosure, and as defined by the appended claims.

What is claimed is:

1. An unmanned aquatic vehicle comprising:
at least one communication device;
at least one steering component;
at least one propulsion component; and
a control system comprising one or more hardware processors, and at least one memory storing one or more instructions which, when executed by the one or more hardware processors, cause the one or more hardware processors to:
determine one or more steering parameters for the at least one steering component and one or more propulsion parameters for the at least one propulsion component to achieve a navigation target;
control the at least one steering component based on the one or more steering parameter and the at least one propulsion component based on the one or more propulsion parameters;
obtain movement data of the unmanned aquatic vehicle over a time interval;
determine a steering effectiveness parameter based on the one or more steering parameters and the movement data over the time interval; and
based on determining that the steering effectiveness parameter below a threshold, cause the at least one communication device to transmit a notification configured to alert a recipient that the unmanned aquatic vehicle may be under control of an unauthorized entity.

2. The unmanned aquatic vehicle of claim 1, wherein the time interval for obtaining movement data is between about 10 seconds and about 90 seconds.

3. The unmanned aquatic vehicle of claim 1, wherein determining that the unmanned aquatic vehicle is likely under control of an unauthorized entity is further based on determining that a speed of the unmanned aquatic vehicle is faster than a threshold speed.

4. The unmanned aquatic vehicle of claim 1, wherein the at least one steering component comprises a rudder.

5. The unmanned aquatic vehicle of claim 1, wherein the at least one propulsion component comprises at least one of a rigid sail and a motor.

6. The unmanned aquatic vehicle of claim 1:
wherein achieving the navigation target comprises navigating a waypoint;
wherein determining the steering effectiveness parameter includes determining progress in navigating to the waypoint.

7. The unmanned aquatic vehicle of claim 1, wherein determining the steering effectiveness parameter includes determining a turn rate based on the movement data.

8. The unmanned aquatic vehicle of claim 1, wherein the movement data includes Global Positioning System (GPS) data.

9. The unmanned aquatic vehicle of claim 1, wherein the instructions, when executed by the one or more hardware processors, cause the one or more hardware processors to:
detect abnormal reverse movement relative to the navigation target at a speed above a threshold speed based on the movement data; and
in response to detecting the abnormal reverse movement, cause the at least one communication device to transmit the notification.

10. The unmanned aquatic vehicle of claim 9, wherein detecting the abnormal reverse movement comprises determining that a longitudinal velocity of the unmanned aquatic vehicle toward the navigation target is negative and has a magnitude greater than the threshold speed.

11. The unmanned aquatic vehicle of claim 1, wherein the instructions, when executed by the one or more hardware processors, cause the one or more hardware processors to:
detect abnormal idle movement comprising the unmanned aquatic vehicle moving at a speed greater than a threshold speed when the at least one steering component and the at least one propulsion component are not under active control; and
in response to detecting the abnormal reverse movement, cause the at least one communication device to transmit the notification.

12. The unmanned aquatic vehicle of claim 1, further comprising:
at least one data collection device configured to collect data; and
at least one storage media configured to store the data;
wherein the instructions, when executed by the one or more hardware processors, cause the one or more hardware processors to carry out a data protection measure to protect the data.

13. The unmanned aquatic vehicle of claim 12, wherein the data protection measure comprises keeping the data at rest in an encrypted form on the at least one storage media.

14. The unmanned aquatic vehicle of claim 12, wherein the data protection measure comprises deleting the data from the at least one storage media.

15. The unmanned aquatic vehicle of claim 12, further comprising:
at least one storage media destruction device communicatively coupled with the control system;
wherein the data protection measure comprises controlling the at least one storage media destruction device to physically destroy the at least one storage media.

16. The unmanned aquatic vehicle of claim 1, further comprising:
at least one scuttling device communicatively coupled with the control system;
wherein the one or more instructions, when executed by the one or more hardware processors, cause the one or more hardware processors to control the scuttling device to sink the unmanned aquatic vehicle.

17. The unmanned aquatic vehicle of claim 1, further comprising:
at least one intelligence gathering device communicatively coupled with the control system;
wherein the one or more instructions, when executed by the one or more hardware processors, cause the one or more hardware processors to:
control the at least one intelligence gathering device to collect intelligence data; and
transmit the intelligence data using the at least one communication device.

18. The unmanned aquatic vehicle of claim 1, further comprising:
at least one disruption device communicatively coupled with the control system;
wherein the one or more instructions, when executed by the one or more hardware processors, cause the one or more hardware processors to control the at least one disruption device to deploy at least one disruption mechanism.

19. The unmanned aquatic vehicle of claim 1, further comprising:
at least one recovery device communicatively coupled with the control system;
wherein the one or more instructions, when executed by the one or more hardware processors, cause the one or more hardware processors to control the at least one recovery device to generate at least one recovery signal.

20. A method for detecting unauthorized control of an unmanned aquatic vehicle, the method comprising:
determining one or more steering parameters for at least one steering component of an unmanned aquatic vehicle and one or more propulsion parameters for at least one propulsion component of the unmanned aquatic vehicle to achieve a navigation target;
controlling the at least one steering component based on the one or more steering parameter and the at least one propulsion component based on the one or more propulsion parameters;
obtaining movement data of the unmanned aquatic vehicle over a time interval;
determining a steering effectiveness parameter based on the one or more steering parameters and the movement data over the time interval; and
when the steering effectiveness parameter is below a threshold, causing at least one communication device to transmit a notification configured to alert a recipient that the unmanned aquatic vehicle may be under control of an unauthorized entity;
wherein the method is performed by one or more processors.
